(19) United States
(12) Patent Application Publication
(10) Pub. No.: US 2005/0120345 A1
(43) Pub. Date: Jun. 2, 2005

(54) Methods and systems for instantly closing browser windows

(76) Inventor: William Nathaniel Carson, Salt Lake City, UT (US)

Correspondence Address: Kirton & McConkie, 1800 Eagle Gate Tower, 60 East South Temple, Salt Lake City, UT, 84111, US

(21) Appl. No.: 10/804,577

(22) Filed: Mar. 19, 2004

Related U.S. Application Data
(60) Provisional application No. 60/456,809, filed on Mar. 22, 2003.

(51) Int. Cl. G06F 9/445

(52) U.S. Cl. 717/174; 717/100

(57) ABSTRACT

Software that causes browser windows and other windows to instantly disappear from a computer screen upon activation of a function activator. Preferably, when a user activates the function activator, the software also causes any open browser applications to shut down as well. The function activator may comprise an icon displayed on the computer screen or a physical switch coupled to the software. Moreover, the software may be incorporated into an Internet Service Provider's browser software or be installed separately from the installation of the browser on the individual user's computer.

### RELATED APPLICATION

This application claims priority to provisional patent application Ser. No. 60/456,809, filed Mar. 22, 2003, for METHODS AND SYSTEMS FOR INSTANTLY CLOSING BROWSER WINDOWS.

### BACKGROUND

1. Field of the Invention

The present invention relates generally to methods and systems for controlling the unwanted multi-media display including images or text. More particularly, the present invention relates to methods and systems for making the operating system instantly terminate computer applications, including Internet browser applications, with a single user command.

2. Background Information

Networked information resources such as the Internet allow users to link to a computer network and access virtually unlimited amounts of electronic information. The benefits of such networks, however, (and especially the Internet) have been somewhat diminished by the advent of programs that force users to view images or text that they would rather not see. Some programs prevent the traditional means of closing browser applications from operating (a “browser” being the software that allows a user to view electronic information on a network, typically the Internet). Some programs even go so far as to cause the user's attempt to close a browser application to cause another undesired screen to pop-up, causing an extremely annoying, never-ending loop of pop-up screens that can only be stopped when the user completely shuts down the computer. This premature shut-down can further cause a multitude of problems, including the loss of any information not previously saved by the user.

Children, especially younger children, can be traumatized by sudden exposure to the lurid and graphic nature of some web sites on the Internet. The sooner a child is able to erase these images from the screen, the better. The same goes for adults. Research has shown that, for some individuals, only one or two brief exposures to violent or sexual pornographic imagery can be addictive. Thus, the aforementioned browser window controlling applications, when used by pornography and scam artists are especially objectionable. Unfortunately, it is not uncommon for a user to be forced to contend with offensive on-screen imagery while he tries desperately to close a never-ending loop of browser screens.

### SUMMARY OF THE INVENTION

The present invention provides software that instantly terminates a computer application with a single user command. In addition the software causes computer-generated windows, particularly browser screens, to instantly disappear from a computer upon activation of a function activator, where the function activator is activated by a single user command. Preferably, when a user activates the function activator, the software also causes any open browser applications to shut down as well. The function activator may comprise a variety of embodiments, including an icon displayed on the computer screen or a physical switch coupled to the software. The present invention teaches that a computer user can activate the function activator with a single command; a single click of the icon or a single actuation of the physical switch. Moreover, the software communicates with and is coupled with to browser in a variety of ways, including by incorporation into an Internet Service Provider's browser software or by installation separate from the installation of the browser on the individual user's computer.

Thus, the present invention helps provide a valuable solution to the increasing problem of forced viewing of undesirable material which may have originated through networked systems such as the Internet or any other software application. In addition, the present invention teaches a method for instantly terminating and causing to disappear any computer application that presents objectionable material regardless of whether the application is designed to prevent a computer user from closing the application. In particular, because embodiments of the present invention permit undesirable, persistent browser applications to be terminated and instantly disappear, users of the Internet can surf with greater peace of mind.

### DETAILED DESCRIPTION OF THE PREFERRED EMBODIMENTS

The following detailed description, in conjunction with the claims, will enable one skilled in the relevant art to make and use the present invention. A purpose of this detailed description being thus to describe the invention so as to enable one skilled in the art to make and use the present invention, the following description sets forth various specific examples, also referred to as “embodiments,” of the present invention. While the invention is described in conjunction with specific embodiments, it will be understood, because the embodiments are set forth for explanatory purposes only, that this description is not intended to limit the invention to these particular embodiments. Indeed, it is emphasized that the present invention can be embodied or performed in a variety of ways. The detailed description is merely representative of particular embodiments of the present invention.

It should be noted that because the present invention is computer-implemented, particular embodiments may range from computer-executable instructions as part of computer-readable media to hardware used to implement the processes herein described. Embodiments of the present invention also include combinations of hardware and computer-executable instructions.

Further, whether the invention is described in terms of a method, a system, an application, a type of software, or as computer-readable media having computer-executable instructions stored thereon, the description is intended to include “instructions” such as program modules, routines, programs, objects, components, data structures, etc., that perform particular tasks within a computing environment. Executable instructions may comprise instructions and data which cause a general-purpose computer, special-purpose computer, or special-purpose processing device to perform a certain function or group of functions.

In addition, computer-readable media may comprise any available media which can be accessed by a general-purpose or special-purpose computer. By way of example and not limitation, such computer-readable media includes any type of RAM (SDRAM, ESDRAM, etc.) or ROM (EPROM, EEPROM, FEPROM, EAROM, etc.) stored on any physical medium, including a computer chip, a server, or a disk. Disks can include optical storage devices (e.g., CD-ROMs or DVD-ROMs), magnetic storage devices (e.g., floppy disks, Zip® disks, or Bernoulli® cartridges), or any other medium that can be used to store the desired executable instructions or data fields and which can be accessed by a general-purpose or special-purpose computer. Combinations of any of the above-named media are also included within the scope of computer-readable media.

Reference will now be made in detail to several embodiments of the invention.

The present invention can generally be characterized as software that terminates any application or process that the invention has rights to terminate under the operating system, and/or causes computer-generated screens, including browser screens, to instantly disappear from a computer monitor upon a single command that activates a function activator. Browsers or browser applications are software that allow information on a network (for example, the Internet) to be viewed on the screen of an individual computer that is connected to the network; browsers can also serve as viewing software for computers that are not connected to a network. Computer-generated screens, including browser applications, are the screens or frames in which text, images, or other information can be displayed. The present invention terminates any application or process that the invention has rights to terminate, and causes open computer-generated windows and/or browser windows to “disappear” in that they become invisible to the user viewing the computer screen via a single command by the computer user to activate the function activator. The disappearance of the screens is “instant” in that there is no wait for the user's computer to process other commands such as a shut-down of the user's computer or a close-down of the user's browser.

Preferably, when the function activator is activated, the software also causes browser applications to shut down as well by terminating the browser application. Once the browser application or browsers have been shut down, the user can start them up anew without being subject to any forced displays of undesirable text or images that may have been instigated when the browser had just been previously open. In addition to an application's instant termination, the present invention teaches preventing cookies from being saved or entries made on the operating system registry by instantly terminating the application and thus not permitting the application to go through its standard closing procedure. In an alternative embodiment of the present invention, an instruction may be included in the termination command that deletes or purges cookies or registry entries. In some embodiments, the system of the present invention emits a sound that indicates when the shut-down of the browser(s) is complete. In some embodiments, the system is designed to shut down at least the most commonly used browser applications. Also, in some embodiments, the software causes the termination or shut-down of any application that generates windows on the computer screen. The present invention teaches that the termination instruction may be customized to selectively and instantaneously terminate any application or process that the invention has rights to terminate under the operating system including a single window or several applications.

The function activator may be activated selectively by a user or automatically when, for example, the system detects the start of a series of looped pop-up screens or any application designed to prevent the user from easily closing it. The function activator may be embodied in a variety of embodiments. User-activated embodiments of the function activator might include an icon displayed on the computer screen or a physical switch coupled to the software or system. Icon embodiments of the function activator may be designed to be always visible, for example, on a system tray or toolbar. Physical switches may be any sort of switch, button, or other physical activator such as a button on a keyboard or on a device that sits next to the computer on a computer desk. Physical switches might be wired or wireless, or even be voice-activated. The present invention teaches the function activator is activated by a single command to increase the speed with which the objectionable material disappears and the application presenting the objectionable material is terminated.

The software of the present invention may communicate with the computer application, a browser or window-generating application in a variety of ways, including by incorporation into an Internet Service Provider's browser software or by installation separate from the installation of the browser or application on the individual user's computer. The software of the present invention can be loaded onto a variety of types of computers such as desktops, laptops, personal digital assistants, or cell phones. In addition, the software of the present invention might be used to terminate the display of content displayed through e-mail applications or through any application that displays web content or content communicated through a network or any other source.

The present invention teaches the software is compatible with any operating system including but not limited to Microsoft, Linux and Macintosh.

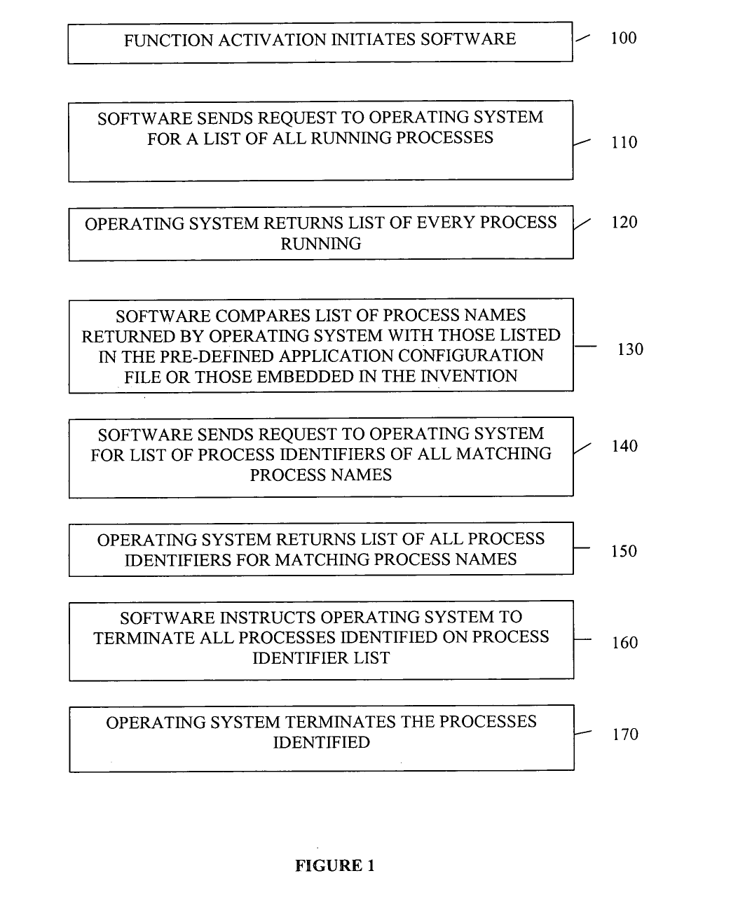

FIG. 1 presents the process of expeditiously terminating a running process. Referring now to FIG. 1, the software is initiated by activation of the function activator 100. The is a function activator may be a click on an on-screen graphic icon, or a press of an external switch. The function activator is a single action or command that instantly initiates the software. The function activator can be activated manually by the user, automatically when a predetermined event or program occurs, or a combination of both.

There is an application configuration file that stores configuration information for the invention. This information can be stored in a variety of ways, such as on magnetic media, flash memory, or over a network, to name a few. The application configuration file is not required for the invention to run since default values can be hard-programmed into the invention.

The application configuration file has a pre-defined list of process names or program names. The list is pre-defined by the manufacturer to include the most common browsers, as well as other program or process names and some applications as the manufacturer decides, but this list can be modified by the user to include any desired program.

Once activated the software sends a request to the operating system for a list of all running processes. 110 The operating system returns a list of every process running. 120 This list of process names returned by the operating system is then compared with the process names listed in the pre-defined application configuration file or those processes embedded in the invention. 130 The software sends a request to the operating system for a list of process identifiers of all matching process names. 140 In this way, the invention is able to identify multiple running processes. As taught by the present invention, the steps of requesting the process names and identifiers can be combined into a single step so that the software requests all running processes and their identifiers in a single quarry.

The operating system then returns a list of all the process identifiers matching process names in the request. 150 The software then instructs the operating system to terminate all processes identified on process identifier list. 160 Finally, the operating system terminates the processes identified in the software's request. 170 Accordingly, the invention terminates the application without interacting with the application by bypassing the application and going directly to the operating system. Sending termination instructions directly to the operating system, as opposed to requesting the application to close, increases the speed and reliability with which the application is closed. In addition the invention breaks any loops or any other traps that may prevent the application from closing quickly.

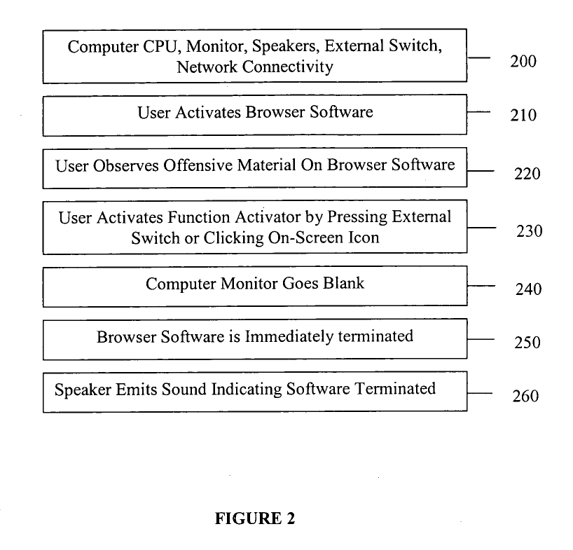

Referring now to FIG. 2, which presents the structure of the present invention as would be experienced by a user. There is a computer CPU with a monitor, speakers, an external switch and network connectivity. 200 The computer is generally a personal computer generally found in in-home use, although the present invention will work with other computer configurations. The user activates browser software 210 typically used when searching the internet.

The user observes offensive material through the browser software 220. Accordingly, the user activates the function activator by pressing external switch or clicking on-screen icon. 230 Upon activation the monitor immediately goes blank, thus clearing any offensive images from the monitor. 240 At the same time the Browser Software is immediately terminated. 250 While the present embodiment teaches terminating a browser software 210, it will be understood to one of ordinary skill in the art, that the present invention may be configured to terminate any software application that the invention has rights to terminate under the operating system. Finally, the computer speaker emits a sound indicated that the software has been successfully terminated. 260

Thus, it is evident that the present invention helps provide a valuable solution to the increasing problem of forced viewing of undesirable material over networked systems such as the Internet or any other source of offensive material including but not limited to text, images, audio files, or movies.

In addition, to the preferred embodiment, the present invention teaches alternative embodiments such as preventing the presentation of material that might be objectionable to a third party even though not objectionable to the computer user, automatically loading the software at startup, so it is, in effect always running, forcing the display of a visual function activator (button to click on) to always be “on top” so other windows cannot hide it, starting in a “minimized” state so the display of a visual function activator isn't shown on the screen, re-launching the applications that where terminated after the completion of the termination action, the invention can play a sound or audio confirmation at the end of the application terminations signaling the completion of the action, displaying a splash screen upon activation of the function activator that obscures everything on the display until the termination sequence is complete, customizing the pre-defined list so the list of applications to be terminated as a result of the function activator being activated. For example a user can add his or her own programs to the kill list, the invention can be activated by a variety of function activators which would include, but not be limited to, a software window, an icon in the task bar, an icon in the system tray, an icon on the desktop, an external switch, some form of signal from another program or from across a network, the invention can automatically submit URLs for review when terminating browsers when activated and the user can choose between “Automatically submit URLs without prompting”, “prompt the customer each time to submit URLs” or to “Never submit URLs for review”. In addition, the present invention teaches sending an application and or system information to remote systems for statistical and troubleshootings reasons. Finally, the present invention teaches expeditiously closing several applications with a single command for convenience even though none of the applications present any offensive material.

Preferred embodiments of the present invention provide the significant advantage of causing browser windows to instantly disappear instead of having to wait for them to disappear after the user's computer finishes processing a complete shut-down of the computer, a close-down of a browser, or other functions that may take time for the computer to process. Indeed, in the preferred embodiments, not only is the user prevented from having to look at undesirable images or text while trying to shut the computer down, the user is also prevented from having to completely shut down the entire computer (as opposed to one or more browser applications) and potentially lose valuable unsaved information in order to terminate any undesirable, or persistent browser windows. The present invention thus allows users of the Internet to surf with greater peace of mind.

It is underscored that the present invention may be embodied in other specific forms without departing from its spirit or essential characteristics. The described embodiments herein should be deemed only as illustrative.

1. A system comprising:
a function activator; and
software for causing at least one computer application to instantly terminate upon activation of said function activator, where said software is activated by a single command.

2. The system of claim 1 further comprising:
a function activator; and
software for causing browser screens to instantly disappear from a computer monitor upon activation of said function activator.

3. The system of claim 1 further comprising software for causing browser applications to shut down upon activation of said function activator.

4. The system of claim 1 wherein said function activator comprises an icon displayed on the computer monitor.

5. The system of claim 1 wherein said function activator comprises a physical switch coupled to said software.

6. The system of claim 1 wherein said software communicates with an operating system running a browser application.

7. The system of claim 1 wherein said software is designed to be installed separately from a browser on the individual user's computer.

8. A system comprising:
means for causing browser screens to instantly disappear from a computer screen upon activation by a user;
means for causing browser applications to shut down upon activation by the user; and
a computer-readable medium comprising computer-executable instructions for installing each of said means.

9. A computer-readable medium comprising instructions for:
causing computer-generated windows to instantly disappear from a computer screen upon activation of a function activator; and
causing certain open applications to shut down upon activation of said function activator.

10. A computer data signal embodied in a transmission medium such as a carrier wave comprising instructions for:
causing browser windows to instantly disappear from a computer screen upon instigation by a user; and
causing any open browser applications to shut down upon instigation by the user.

11. A method comprising:
causing windows to instantly disappear from a computer screen upon activation of a function activator; and
causing browser applications to shut down upon activation of said function activator.
